(19) United States
(12) Patent Application Publication
(10) Pub. No.: US 2010/0028010 A1
(43) Pub. Date: Feb. 4, 2010

(54) Method and system for updating a control device database via flashing light

(75) Inventors: Yonghong Zhao, North Potomac, MD (US); Roshan Menon, Hermosa Beach, CA (US); Eric J. Bennett, Los Angeles, CA (US); Kim W. Schulze, Los Angeles, CA (US); Jorge H. Guzman, Gaithersburg, MD (US); Roger J. Lambert, Pacific Palisades, CA (US)

Correspondence Address: THE DIRECTV GROUP, INC.;PATENT DOCKET ADMINISTRATION, CA / LA1 / A109, 2230 E. IMPERIAL HIGHWAY, EL SEGUNDO, CA, 90245, US

(73) Assignee: The DIRECTV Group, Inc.

(21) Appl. No.: 12/082,616

(22) Filed: Apr. 11, 2008

(51) Int. Cl. H04B 10/00

(52) U.S. Cl. 398/106

(57) ABSTRACT

A system for delivering codes to a remote control for controlling a number of electronic devices includes a receiver for receiving a signal from a transmitter. A display connected to the receiver has a mechanism for flashing visible-light to the remote control, the flashed visible-light being related to the signal. The remote control includes a code database and mechanisms for receiving flashed visible-light and converting it into a code storable in the database. A method for acquiring updated codes includes storing codes for controlled apparatus in a code database. Data related to additional device codes are then transmitted to a processing device connected to a visual display. The data are flashed as visible-light from the display and received by the remote control. Received visible-light is converted into at least one device code and used to update the code database in the remote control.

### CROSS-REFERENCE TO PRIOR APPLICATIONS

Not Applicable

### U.S. GOVERNMENT SUPPORT

Not Applicable

### BACKGROUND OF THE INVENTION

The present invention relates generally to programming a control device. More particularly, the present invention relates to using visible-light to provide a remote control device with updated device codes.

A remote control is an electronic device used for the remote operation of a machine or electronic device. Typically, a remote control is used to issue commands from a distance to a television (TV) or some other consumer electronic device (e.g., stereo systems, video cassette recorders (VCR), digital video disc (DVD) players, digital video recorders (DVR), etc.). In the 21^{st} Century, many homes have so many consumer electronic devices that there may be as many as four or more remote control devices in just one room of any given home. For example, in order to operate a home theater system, a user may require one remote control for a cable or satellite receiver, another remote control for the VCR, a further remote control for the DVD player, yet another remote control for the TV and audio amplifier, etc. Often, these remote controls must be used sequentially, and this can be confusing, unwieldy and frustrating to the user.

Remote control devices associated with these consumer electronic devices are usually small, wireless, handheld objects with an array of buttons for adjusting various settings such as channel/station, volume, on/off, etc. Most remote controls are battery-powered and communicate to their respective devices via infra-red (IR) and/or radio signals. Usually, each brand/manufacturer assigns a particular and/or unique IR device code (usually in the form of a number) to the particular device the remote control is communicating with and/or controlling. Each IR device code identifies an associated collection of particular and/or unique IR device commands. Each IR device command comprises a series of bits corresponding to a function on a device (e.g., “volume up”, “volume down”, “channel up”, “channel down”, “on/off” or the like). Thus, a user's selection of a particular device code automatically selects the device commands associated with that particular device code. The IR device command is determined by the original manufacturer of the device (e.g., Sony determines the IR device commands for a Sony TV). The IR device code is determined by the manufacturer of a remote control associated with a particular device (e.g., a TV, VCR, etc.) and may only function for that particular remote control model. Thus, an electronics manufacturer can assign a particular IR device code (i.e., the device code itself comprising one or more device commands) to a specific brand/model TV set it manufactures and another particular IR device code (comprising one or more device commands) to a specific brand/model VCR it also manufactures. Other electronics manufacturers use different IR device codes (comprising one or more device commands) for their products.

A universal remote control device is a type of remote control device that can be programmed to operate various brands of one or more types of consumer electronic devices. Some universal remote control devices can only control a set number of consumer electronic devices, as determined by the number of device codes (and their associated device commands) programmed into the remote control device by the manufacturer of the universal remote control device, while other universal remote control devices allow the user to program in new control device codes (and their associated device commands) to the universal remote. Typically, universal remote control devices have built-in descriptions, commonly referred to as a code library or database, on how to communicate with other devices such as TV's and DVD players. These code libraries may be in the form of collections of device commands; each collection being identified by a particular device code. The code library or database stores all the device codes and their associated device commands. However, as new consumer electronic devices are constantly entering the marketplace, these code libraries become outdated over time and the remote control device must be updated to accommodate this. A printed list of device codes may come with the remote control at the time the remote control is purchased as either a stand-alone product or included with a consumer product (e.g., TV, VCR, etc.). The printed list of device codes represents device codes (and their associated device commands) already programmed into the remote control device. However, this list of device codes may already be out-of-date at the time purchase due to ever increasing numbers of new consumer electronic devices coming into the marketplace. The current method of “updating” a remote control device is to replace it with another remote control device having a newer, more recent code library or database. The old remote control device may be thrown away, cannibalized for parts or refurbished with an updated code library in order to replace a remote control with an outdated code library.

Even remote control devices sold with a particular electronic device may include universal remote capabilities for other types of devices, which allows the remote control device to control other devices beyond the particular device (e.g., a VCR remote programmed to operate various brands of televisions) the remote control came with at the time of purchase. Large numbers of device codes (and their associated device commands) for various brands and models of electronic devices can be stored within a memory of a remote control device (i.e., in a code library or database within the memory). As the number of devices increases, the number of device codes and their associated device commands in the code library or database (stored in a non-volatile storage memory in the remote control device) also increases. The code library or database is loaded into the remote control device at the time the remote control device is manufactured. Most universal remote controls sold today are device-based remote controls where the user presses a button associated with a desired device (e.g., a TV) to select that device (i.e., the TV) for control and then uses the remaining buttons to actually control the functions of that single device (i.e., the TV). To start controlling another device (e.g., a VCR), the user presses a different device button (i.e., the button marked “VCR”) and the remote then starts sending commands to the new device (i.e., the VCR). Typical “mode” buttons on this type of remote control device are labeled “TV”, “DVD”, “Receiver”, etc. Each different type of device (e.g., TV, VCR or the like) controlled by the same remote control more than likely uses a different device code (i.e., the device code for the TV is different from the device code for the VCR even if both devices were made by the same brand manufacturer).

A television set-top box (e.g., a satellite broadcast set-top box, a cable converter box, etc.) may also include a remote control code library or database having a number of device codes and associated device commands in order to aid a consumer in programming the remote control associated with the set-top box to be used to control various other devices (e.g., a TV, a DVD player, an audio system, etc.). Typically, the term “set-top box” (STB) describes a device that connects to a TV and some external source of signal, and turns the signal into content then displayed on the TV screen. Before cable-ready TV sets, a set-top box known as a cable converter box was used to receive analog cable TV channels and convert them to video that could be seen on a regular TV. Cable converter boxes are still used to descramble premium cable channels and to receive digital cable channels through a coaxial cable that is operationally connected to a cable service provider.

STBs are also well-known to consumers who subscribe to a satellite broadcast network. Most satellite TV customers get their programming through a direct broadcast satellite (DBS) provider (e.g., DirecTV). The provider selects programs and digitally broadcasts them to subscribers as a set package. There are five major components involved in a direct to home (DTH) satellite system: the programming source, the broadcast center, the satellite, the satellite dish and the receiver (i.e., the STB). Programming sources are simply the channels that provide programming for broadcast. The broadcast center is the central hub of the system. At the broadcast center, the television provider receives signals from various programming sources and beams a broadcast signal to satellites in geostationary orbit. The satellites receive the signals from the broadcast station and rebroadcast the signals to the ground. The subscriber's dish picks up the signals from the satellite (or multiple satellites) and passes the signals on to the STB in the subscriber's house. The STB processes the signals and passes the signals on to a TV connected to the STB. The STB is also known as an Integrated Receiver and Decoder (IRD).

Like the remote control device, as the number of different brands/models of consumer electronic devices increases, the database (stored in a non-volatile storage memory in the STB) also increases. Like the code library or database in the remote control device, a code library or database is loaded into the STB at the time the STB is manufactured. This makes the code library or database in the STB as static as the code library or database in the remote control device. Likewise, the STB may be equally in need to be updated as new types, models and brands of consumer electronic devices enter the marketplace. A user seeks to control a desired device (e.g., a TV) by selecting the type of desired device (i.e., the TV) and brand name (e.g., SONY) of the desired device (i.e., the TV) that are stored in the programming codes in the fixed database of the STB. The user can access these device codes through a set-up feature associated with the STB. The user programs the remote control device with one of the codes and tests the remote control device by trying to use the remote control device on the desired device (i.e., the TV). If the desired device (i.e., the TV) responds, programming is stopped. However, there is a chance that the desired device (i.e., the TV) may not work and another code may be entered. As with programming the remote control device using codes stored in the remote control device's code library or database, as outlined below, several device codes may be entered before the proper code for the desired device is found.

Problems arise when a user purchases a new and/or updated brand/model of electronic device (e.g., a new television, a new audio/stereo system, a new DVR, etc.) and the user's universal remote control device does not work with the new electronic device. Manufacturers of consumer appliances and devices often reuse the same device codes on many similar devices (though for each manufacturer and device type, there are usually multiple device codes in use since there may be several different models of the same type of device made by the manufacturer). Thus, a new device may share the same IR code as an older device made by the same manufacturer. However, as time goes by, new device codes can be added and/or old device codes modified and/or updated. A universal remote control device that was designed for use when VCRs dominated the marketplace may not function with a relatively new consumer electronic device, such as a DVR. Thus, after a few years, the code library or database of device codes within the remote control device can become outdated and unable to function with new devices. Depending on the age and quality of the remote control device, the memory of the remote control device may not include the device codes for relatively new consumer electronic devices. In this case, the memory within the remote control device must be updated with device codes that correspond to new and/or updated electronic devices. Thus, there is a need for a way to update remote control devices with new device codes and/or associate old device codes with newer consumer electronic devices. In sum, while remote control devices that are able to control multiple consumer electronic devices have “built-in” descriptions (i.e., codes) of how to communicate with other consumer electronic devices, as new devices are made, these “built-in” descriptions become out-dated unless the code library or database of the remote control device can be updated.

If a remote control device having universal remote functionality does not work with a particular new device that a consumer has purchased, the consumer can check the user's manual that came with the universal remote device when the consumer purchased it (i.e., if the user can even find his/her user's manual assuming that he/she even bothered to keep the user's manual), and then look up the appropriate device code for the particular device (i.e., brand, type of device, model, etc.) he/she purchased as well as the steps on how to program the remote control device to associate the appropriate device code with the new consumer electronic device. Although most users of remote control devices often have no difficulty operating a remote control device after the remote control device has been set-up and/or programmed for them, the very act of programming a universal remote control device can be a daunting process to technologically-unsophisticated individuals who have trouble understanding the programming instructions for the remote control device that require certain buttons to be pushed in certain sequences. Typically, a user will contact a customer service representative via telephone in order to learn the appropriate device code for the new consumer electronic device and be instructed in how to program the remote control device into associating the device code with the new consumer electronic device. While this helps the user, telephone calls to customer service call centers can be costly when one adds up all the thousands upon thousands of code-related customer service calls made each year by consumers. In some cases, it may be necessary for either the customer, cable company or DBS provider to incur the expense of replacing the remote control device if the remote control device is not responsive to any of the device codes provided to the consumer.

Some universal remotes allow the list of codes programmed into the database of the remote control device to be updated to support new brands or models of devices not currently supported by that remote control device. Some universal remote control devices accomplish this by allowing audible signals to be sent over a telephone to a receiver on the remote. If the remote user calls customer service, an operator can have the caller place the remote control device next to the telephone's speaker and then send a signal over the telephone to an audio receiver of the remote control device in order to upgrade the remote control device for any requested new brand or model of a particular type of supported consumer electronic device. A drawback to this approach is that the audio receiver on the remote control device may not be sensitive enough to pick up the audio signal and/or the telephone's speaker does not emit a clear enough audio signal for the remote control device's audio receiver to pick up on. Another drawback is that background noise can interfere with and distort the audio signal picked up by the remote control device's audio receiver. Other models of remote control devices allow codes to be upgraded by connecting the remote control device to a personal computer via a USB cable or the like and the new and/or updated codes are downloaded into the memory of the remote control device. Still other remote control devices have IR learning features that allow the remote control devices to “learn” the code for any button on many other IR remote controls. This functionality allows the remote control device to learn functions not supported by default for a particular device. A drawback of this approach is that the learning remote control device needs a functioning teaching remote control device.

Accordingly, there is a need for an improved system and method for adding/updating consumer electronic device codes in a remote control device. There is also a need for a system and method that reduces the need to periodically replace remote control devices. There is a need for a system and method that provides a remote control device that can “learn” the commands of new consumer electronic devices and update the code library or database of the remote control device. There is also a need for an improved system and method to transmit these updated/new codes to the remote control device without the need for cables or teaching remotes. There is a further need for a system and method of adding/updating device codes in the code library or database of a remote control device that reduces and/or eliminates the need for a user to consult a customer service representative. There is an additional need for a system and method of adding/updating device codes in a remote control device that uses existing communications connections between the remote control device and the source of the new/updated device codes. The present invention satisfies these needs and provides other related advantages.

### SUMMARY OF THE INVENTION

The present invention is useful in a variety of ways. The system and method embodying the present invention uses visible-light from a display (e.g., a computer monitor, a television or the like) to program a remote control device with updated IR, RF or visible light device codes delivered to a receiver (via satellite or other broadcast system) connected to the display. The present invention reduces the need for a consumer to speak with a customer service representative at a call center in order to obtain updated device codes. The present invention keeps a device code database current. The present invention further reduces the need to periodically replace remote control devices. The system and method aim to make the code library or database in the remote control device updatable by the end user.

The method and system for updating the code library of a remote control device is based upon flashing visible-light shown on a video display (e.g., a television, a computer monitor or the like) to a remote control device capable of receiving visible-light and converting the visible-light into an electrical signal that can then be processed into a code to be stored in the code library of the remote control device. As mentioned above, the method and system can be based on an STB connected to a TV where custom-built mpeg streams are used to display the flashing lights. Alternatively, the method and system can be based on a personal computer having a computer monitor.

In accordance with an embodiment of the present invention, a system delivers device codes to a remote control having a device code database whereby the remote control is capable of controlling a number of electronic devices via at least one device code specific to each electronic device. This system includes a receiver for receiving a signal originating from a transmitter. A display is operationally connected to the receiver. The display has a mechanism for flashing visible-light to the remote control, wherein the visible-light is related to the signal.

The remote control includes a mechanism for receiving the visible-light. The mechanism for receiving visible-light comprises a light dependent resistor (LDR). A lens disposed between the LDR and the display focuses light on the visible-light receiving mechanism. The remote control also includes a mechanism for converting the received visible-light into at least one device code to be stored in the device code database. The mechanism for converting the received visible-light comprises a microprocessor. The remote control is positioned adjacent to the display in order to reduce visible-light incoming to the remote control from light sources other than the display.

The remote control includes a mechanism for adjusting the mechanism for flashing visible-light. The mechanism for flashing visible-light comprises a graphical user interface on the display and/or an area of the display running a video stream. The area of the display running the video stream is adjustable in size to accommodate a light-receiving end of the remote control. The mechanism for flashing visible-light also comprises a non-flashing dark border portion projected on the display surrounding a visible-light flashing portion projected on the display.

A light shield engages the remote control about the light-receiving end in order to reduce the amount of ambient visible-light reaching the light-receiving end of the remote control.

The system also includes a mechanism for initiating a device code update. The system additionally includes a satellite disposed between the transmitter and the receiver, receiving an uplink signal comprising the signal from the transmitter. The signal received by the receiver comprises a downlink signal from the satellite, wherein the downlink signal is related to the uplink signal, and the visible-light flashed to the remote control is related to the downlink signal. The uplink signal is related to the at least one device code.

In accordance with another embodiment, a method for acquiring updated device codes for a controlled apparatus, comprises storing a plurality of device codes for a plurality of controlled apparatus in a code database of a remote control. Data related to additional device codes are generated and the generated data are transmitted from a transmission source to a processing device operationally connected to a display.

The generated data are flashed in the form of visible-light from the display to the remote control. The flashed visible-light is received in the remote control and converted into at least one device code. The code database is updated in the remote control with the at least one device code.

The transmitting step includes routing the generated data through a satellite network to the display.

The method includes using the remote control to access the generated data. The method also includes using the remote control to operate different controlled apparatus, wherein the different controlled apparatus are manufactured by at least one manufacturer.

A particular device code is selected from a plurality of device codes to operate a particular controlled apparatus. According to the method, at least one of the device codes is used to operate a particular controlled apparatus. The particular controlled apparatus is a selected one of a television, a CD player, a DVD player, a DVR, a stereo system, a VCR, a personal computer, a personal digital assistant; a cable converter, and a set-top box.

The method includes adjusting a graphical user interface projected on the display in order to flash the visible-light. The method further includes initiating a device code update.

Other features and advantages of the invention will become more apparent from the following detailed description, taken in conjunction with the accompanying drawings which illustrate, by way of example, the principles of the invention.

### BRIEF DESCRIPTION OF THE DRAWINGS

The accompanying drawings illustrate the invention. In such drawings:

FIG. 1 is a block diagrammatic view of an illustrative system;

FIG. 2 is a block diagrammatic view of a set top box;

FIG. 3 is block diagrammatic view of a remote control;

FIG. 4A-4G are screen displays of various aspects of a graphical user interface used during programming of a remote control device;

FIG. 5A-5C are screen displays of various aspects of a graphical user interface used to flash light to a remote control device during programming of the remote control device;

FIG. 6 is a diagrammatic view of a broadcast remote control configuration database;

FIG. 6 is a flowchart illustrating a method for operating the present disclosure;

FIG. 7 is a flowchart illustrating a method for operating the present disclosure;

FIG. 8 is a diagrammatic view of a system for programming a remote control device;

FIG. 9 is a diagrammatic view of a database record;

FIG. 10 illustrates the steps in encoding data and building a data frame;

FIG. 11 is a diagrammatic view illustrating video signal generation in a set top box;

FIG. 12 is another block diagrammatic view of a remote control;

FIG. 13 is an illustrative light detection circuit; and

FIG. 14 is a process flow for updating one or more records in a remote control.

### DETAILED DESCRIPTION OF THE PREFERRED EMBODIMENTS

The present invention is an improved system and method for adding/updating device codes in a remote control. The present invention provides a system and method to transmit these updated/new codes to the remote control without the need for cables or teaching remotes. The present invention further provides a system and method of adding/updating device codes in a remote control that reduces and/or eliminates the need for a user to consult a customer service representative. The present invention further provides a system and method of adding/updating device codes in a remote control that uses existing communications connections between the remote control and the source of the new/updated device codes. For purposes of clarity, the same reference numbers will be used in the figures to identify similar elements. As used herein, the term “module” refers to an Application Specific Integrated Circuit (ASIC), an electronic circuit, a processor (shared, dedicated, or group) and memory that execute one or more software or firmware programs, a combinational logic circuit, and/or other suitable components that provide the described functionality. It should also be understood that steps within a method may be executed in different order without altering the principles of the present description

While the following description is made with respect to example DIRECTV broadcast services and systems, it should be understood that many other delivery systems are readily applicable to disclosed systems and methods. Such systems include other wireless distribution systems, wired or cable distribution systems, cable television distribution systems, Ultra High Frequency (UHF)/Very High Frequency (VHF) radio frequency systems or other terrestrial broadcast systems (e.g., Multi-channel Multi-point Distribution System (MMDS), Local Multi-point Distribution System (LMDS) or the like), Internet-based distribution systems, cellular distribution systems, power-line broadcast systems, any point-to-point and/or multicast Internet Protocol (IP) delivery network, and fiber optic networks. Further, the different functions collectively allocated among a head end (HE), integrated receiver/decoders (IRDs) and a content delivery network (CDN) as described below can be reallocated as desired without departing from the intended scope of the present invention.

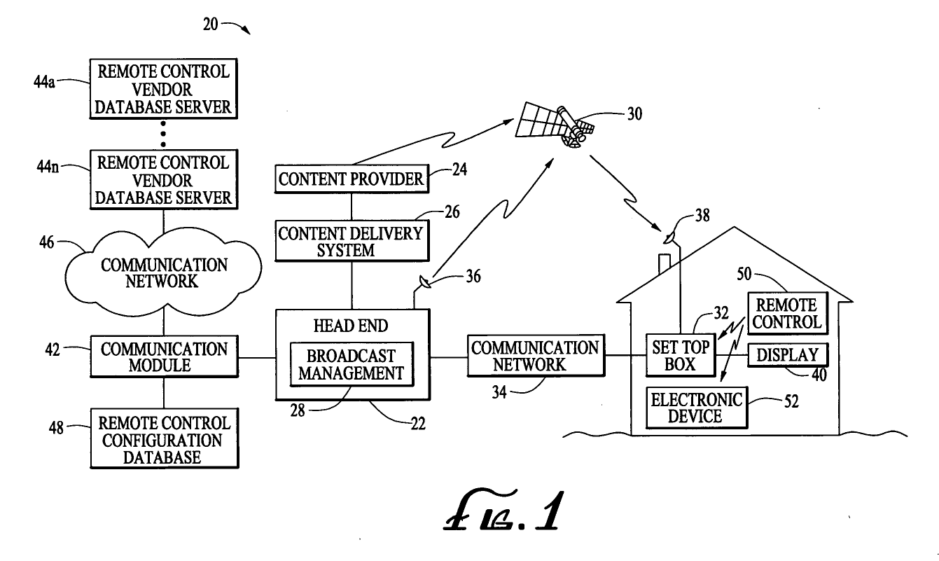

As shown in the drawings for purposes of illustration, the present invention is concerned with a method and system for updating a code library of a remote control device, as seen in FIGS. 1-14. A communications system 20 includes a head end 22 that is used as a transmitter or transmission source, a plurality of content providers, one of which is shown as reference number 24, and a content delivery system 26. The content providers 24 may deliver content through the content delivery system 26 to the head end 22. The head end 22 may include a broadcast management module 28 used for broadcasting the content and various other data, such as remote control configuration data as will be described below. A satellite 30 may represent several satellites or a network of satellites. The satellites 30 may be used to communicate the different types of information or portions of content from the head end 22 to a user device such as a set top box 32 which acts as a receiver. The set top box 32 may also be referred to as an IRD. Communications through the satellite 30 may take place at any suitable frequency including, but not limited to, Ka band, Ku band, C band or the like. Signals to the satellite 30 are known as uplink signals while signals from the satellite are known as downlink signals. The user device can also come in various other forms including, but not limited to a personal computer, a cable converter box, a portable media player, a personal digital assistant, a cellular telephone or the like.

In addition to the satellite 30, various types of information including, but not limited to, security information, encryption and decryption information, content, or remote control configuration database information may be communicated terrestrially using various communications networks 34 including, but not limited to, public switch telephone networks, cellular telephone networks, terrestrial wireless systems, stratospheric platforms, optical fiber networks, coaxial cable systems, cable television systems, broadcast television, or the like. In a cable television system, all content and the remote control data are communicated terrestrially. Data and content may be communicated through an uplink antenna 36 through the satellite 30 which, in turn, communicates the signals to a receiving antenna 38 in communication with the set top box 32. The set top box 32 is in communication with and/or operationally connected (e.g., electro-mechanically) to a display 40. The display 40 can come in various forms including, but not limited to, a television monitor, a computer monitor, as part of a portable media player, as part of a personal digital assistant, as part of a cellular telephone, as part of an mp3 player or similar device, as part of a digital camera, or any other device that includes a display that is capable of running graphics and/or video.

A communication module 42 may be in communication with the head end 22. It should be noted that communications module 42 may be included within the head end 22 or as a separate device. The communication module 42 is used for communicating with a remote control vendor database server 44. The remote control vendor database server 44 may collectively comprise a number of individual remote control vendor database servers. The remote control vendor database server includes a database of remote control devices provided by a particular vendor. This database includes types of devices, model numbers of the devices, brands of the devices, and programming information related to the devices including, but not limited to, programming codes. The communications module 42 communicates with the remote control vendors through a communication network 46. The communication network 46 includes various types of communications mechanisms set forth with respect to the communication network 34. However, the communication network 46 may be differently configured than the communication network 34 (i.e., the communication network 46 in any configuration may be different than the communication network 34 in an implementation).

The communication module 42 is in communication with the remote control configuration database 48. The communication module 42 may be computer-based such as a server. The remote control configuration database 48 may be a memory within the communication module 42 or within the head end 22. The remote control configuration database 48 is updated periodically through the communication module 42. The communication module 42 may receive a notification that the remote control vendor database of a particular remote control vendor has been updated. The communication module 42 may then retrieve the information. The remote control vendor database server 44 may also periodically send updates to the communication module 42 automatically. As is evident, various ways for receiving and updating the remote control configuration database 48 may be performed.

The set top box 32 is in communication with a remote control device 50. The remote control 50 is able to communicate (send and/or receive) with the set top box 32 and/or another electronic device 52 using various types of communication including, but not limited to, infra-red (IR), radio frequency (RF), visible light or the like.

The electronic device 52 may have a remote control input that may be desirable to be controlled by the remote control 50. The electronic device can come in various forms including, but not limited to, a television, a CD player, a DVD player, a DVR, an audio/stereo system, an alarm system, a VCR, a personal computer, a personal digital assistant; a cellular telephone, a cable converter box, a set-top box or the like. The discussion, above and below, relates to a method to update the programming of the remote control 50 that allows the remote control 50 to operate one or more of the foregoing electronic devices 52.

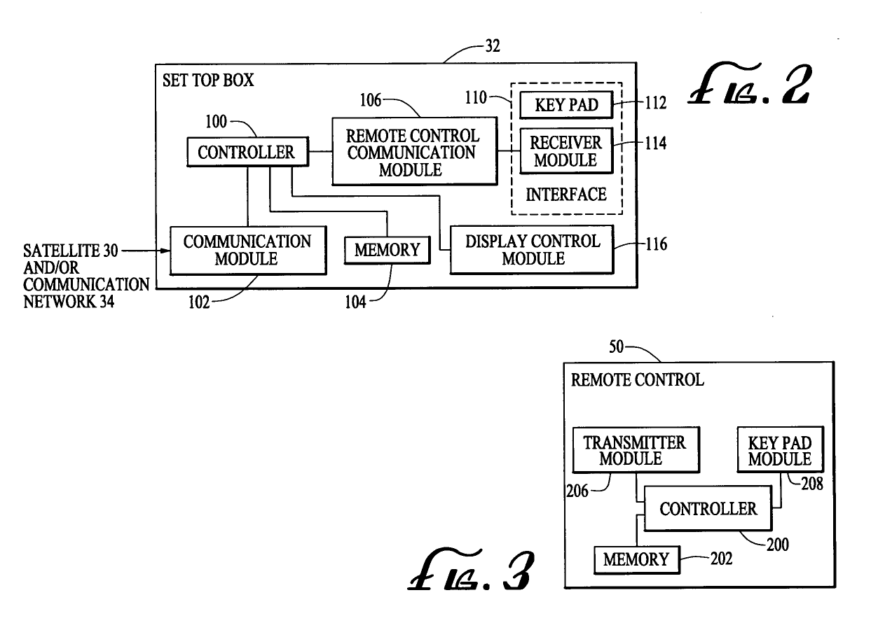

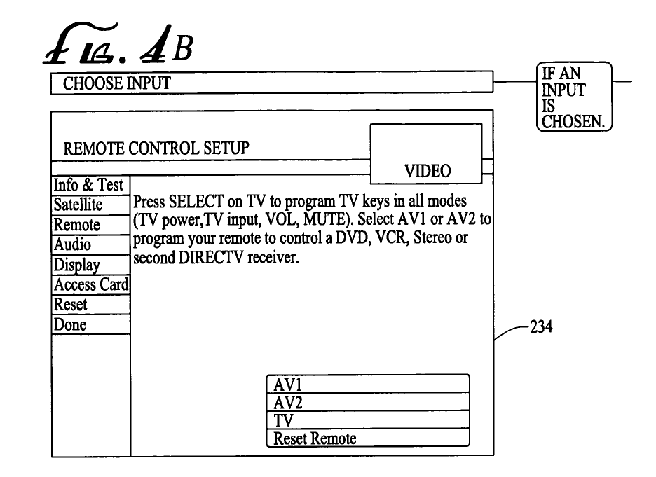

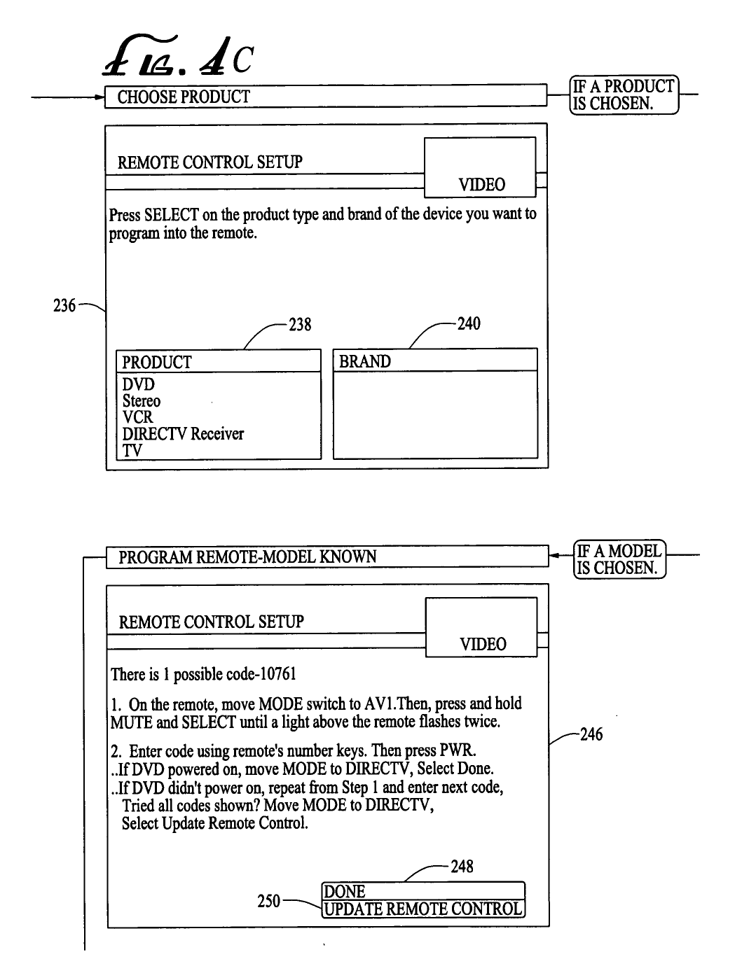

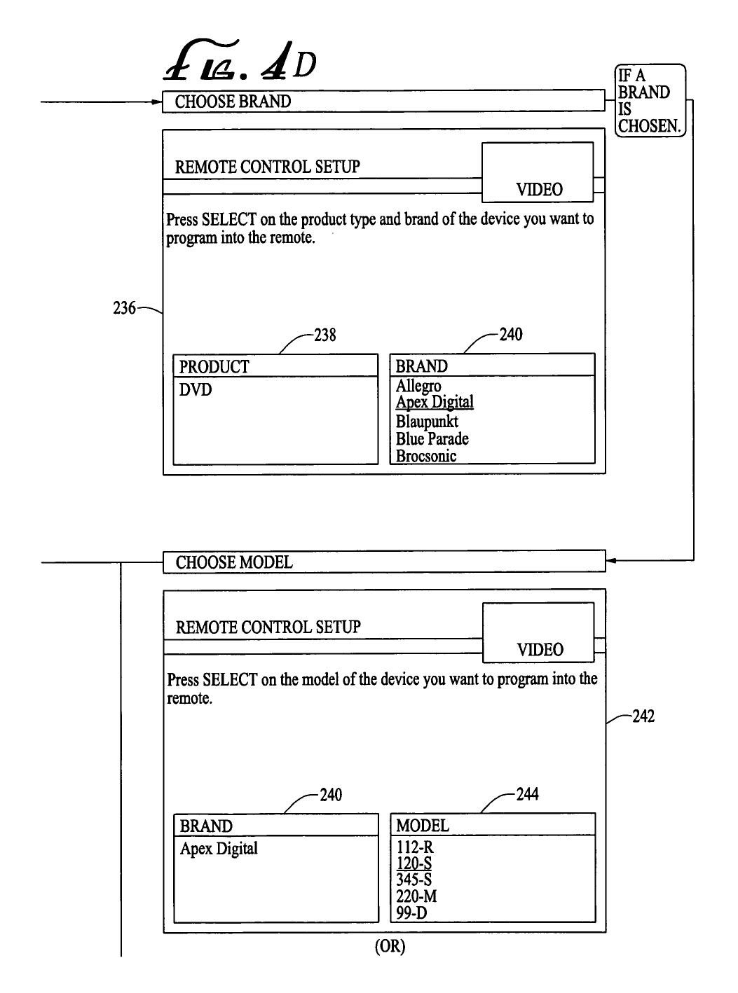

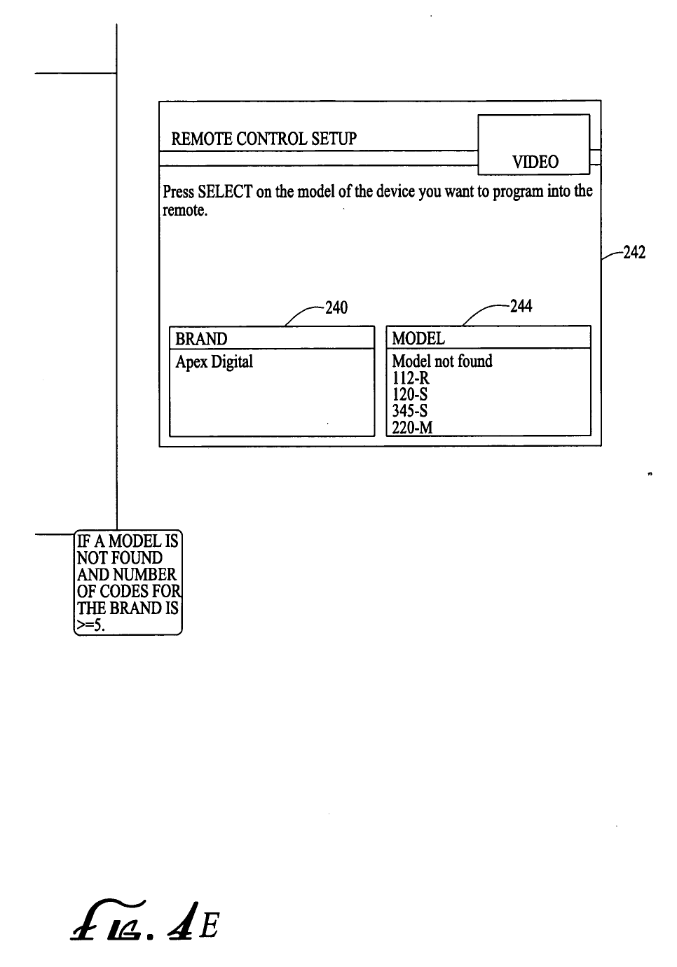

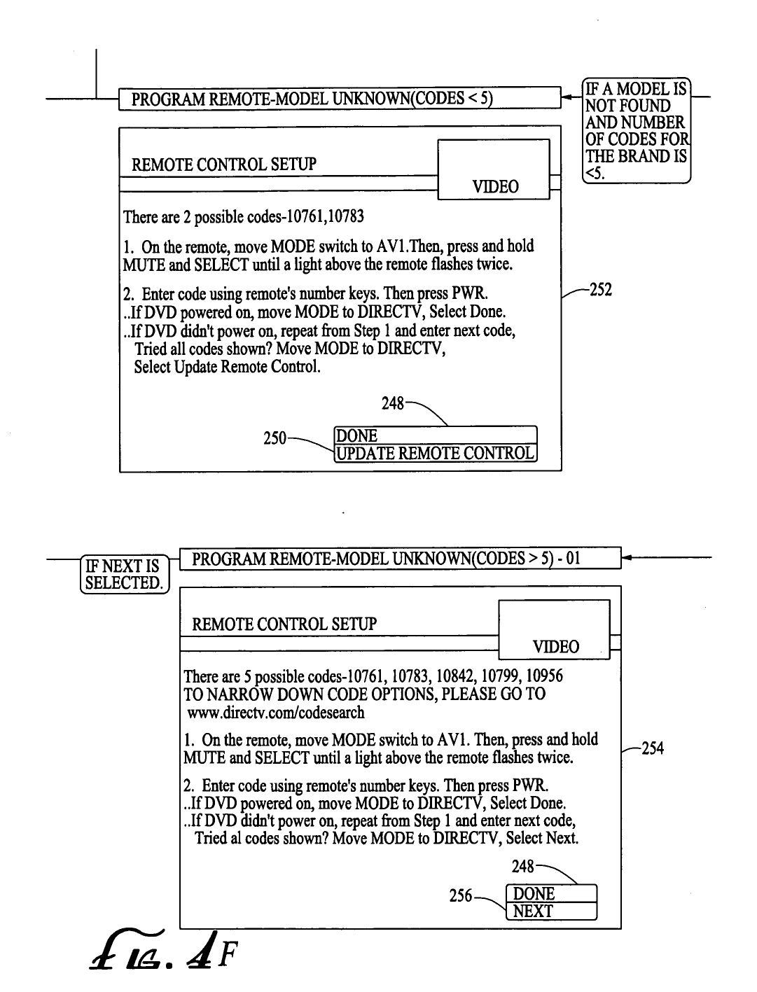

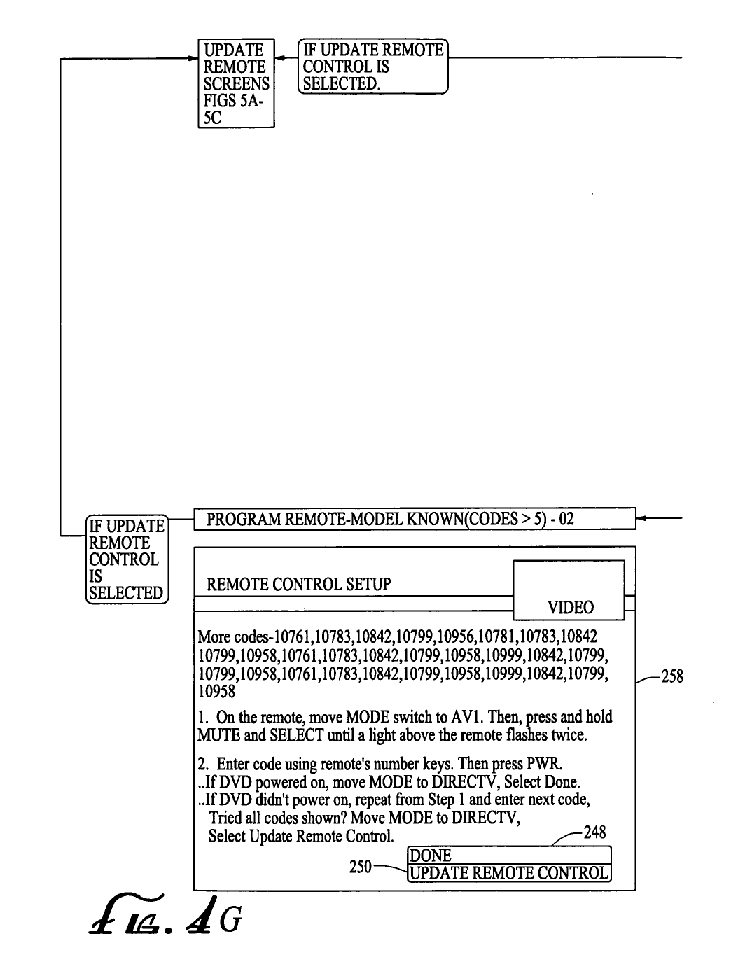

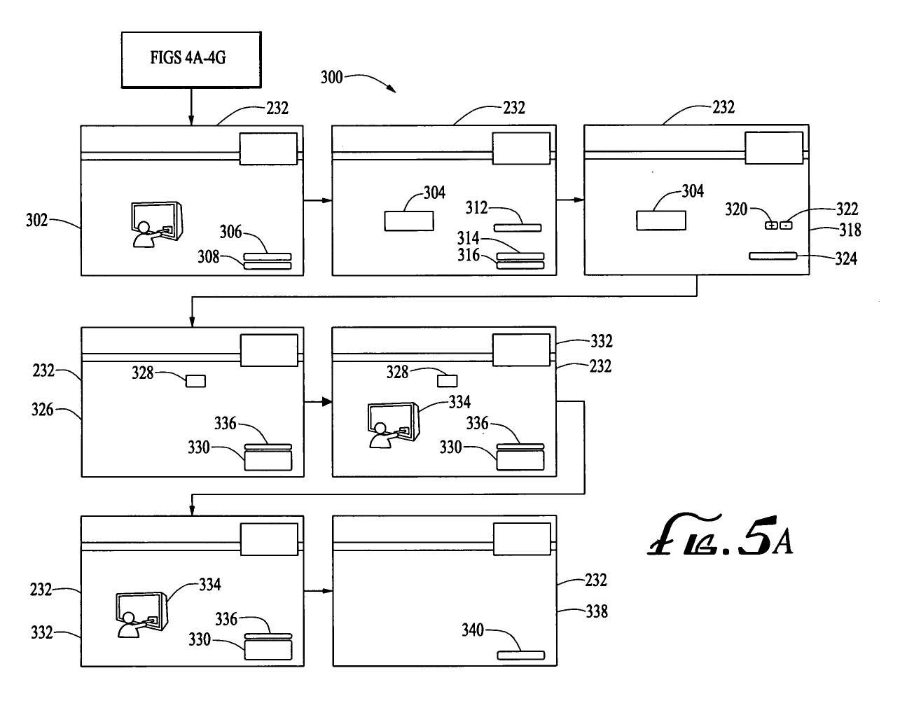

As seen in FIG. 2, the set top box 32 includes a controller 100 that is in communication with a communication module 102. The communication module 102 is used to communicate through the communication network 34, the satellite 30 and/or both. The communication module 102 may be used to receive various types of information including, but not limited to, some or all of the contents of the remote control configuration database 48 and other content. The controller 100 may store the remote control communication database within a memory 104. The memory 104 may include various types of memory, including a flash memory. All or only portions of the remote control configuration database 48 can be stored in the memory 104. The communication module 102 is capable of monitoring the data within the database 48 and retrieving the data according to a remote control communications module 106. The remote control communications module 106 is used to control the programming of the remote control 50 through the set top box 32. The remote control communications module 106 is in communication with an interface 110 that may include a key pad 112 directly on the set top box 32 or a receiver module 114, or both. The receiver module 114 may include an RF, IR or visible light interface for communicating with the remote control device 50. The controller 100 may also be coupled to a display control module 116 which operates in response to the remote control communications module 106. That is, various screen displays may be generated for the programming of the remote control device 50. This allows the user to interact with the set top box 32 for the programming. The remote control communications module 106 may be activated using a screen display for configuring the remote control device 50. Once the remote control process is activated through the interface 110, various screen displays may be generated on the display 40 through the display control module 116. Selections by the interface module 110 will control the communications module 102 to obtain various information from the broadcasted remote control configuration database. The operation of the set top box 32 and screen displays is further described in FIGS. 4A-6.

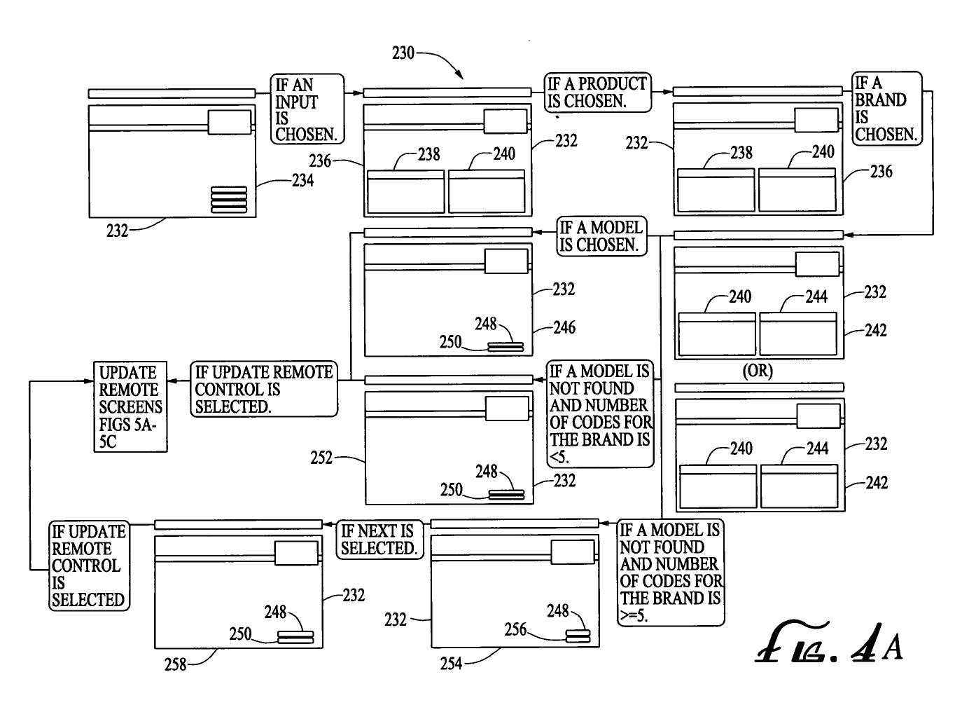

According to FIG. 3, a remote control 50 is illustrated in further detail. The remote control 50 may also include a controller 200 that is coupled to a memory 202. The memory 202 may store various configuration information received from the set top box 32. The controller 200 may be used to control a transceiver module 206 that may be used to transmit RF, IR or visible light signals to the interface 110 of the set top box 32. A keypad module 208 generates various signals that are communicated through the transmitter module 206 and, ultimately, to the interface 110 of the set top box 32. The memory 202 may include a database of various types of configurations for the remote control device 50. The keypad module 208, as described below, may be used to configure the remote control device 50 to a particular configuration within the remote control database within the memory 202.

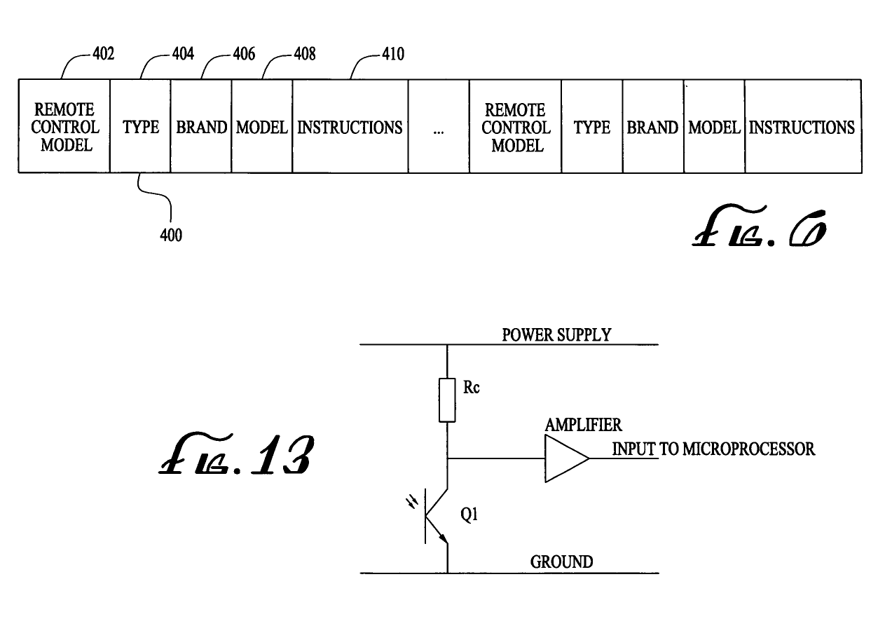

For purposes of illustration, as seen in FIG. 8, the set top box 32 is connected to the display 40 (in the form of a television which, in this case, serves as both the display 40 and one of the electronic devices 52 to be controlled by the remote control device 50) for updating the remote control code library by flashing modulated visible-light shown on the display 40 to the remote control device 50 which has a mechanism for receiving the flashed visible-light and converting the flashed visible-light into a new code to be stored in the code library. In the alternative, the visible-light can be flashed to the remote control device 50 by a light emitting diode on the set top box 32. The set top box 32 will have the code library, or portions of the code library stored in its memory 104. Updates to the code library on the set top box 32 are done through a download via a satellite signal 54 from the satellite 30 or a broadband signal 56 from a cable television system or the like. Alternatively, a personal computer can be substituted for the set top box 32, and the computer's monitor serves as the display 40. The personal computer may likewise be connected to receive a satellite signal 54 from a satellite system 30 or a broadband signal 56 from a cable television system or the like. A button on the remote control device 50 can be depressed to activate a program stored in the memory 104 of the set top box 32. The microprocessor or controller 100 of the set top box 32 then runs a program that starts the graphical user interface, described above and below, that the user interacts with to update the code library of the remote control device 50.

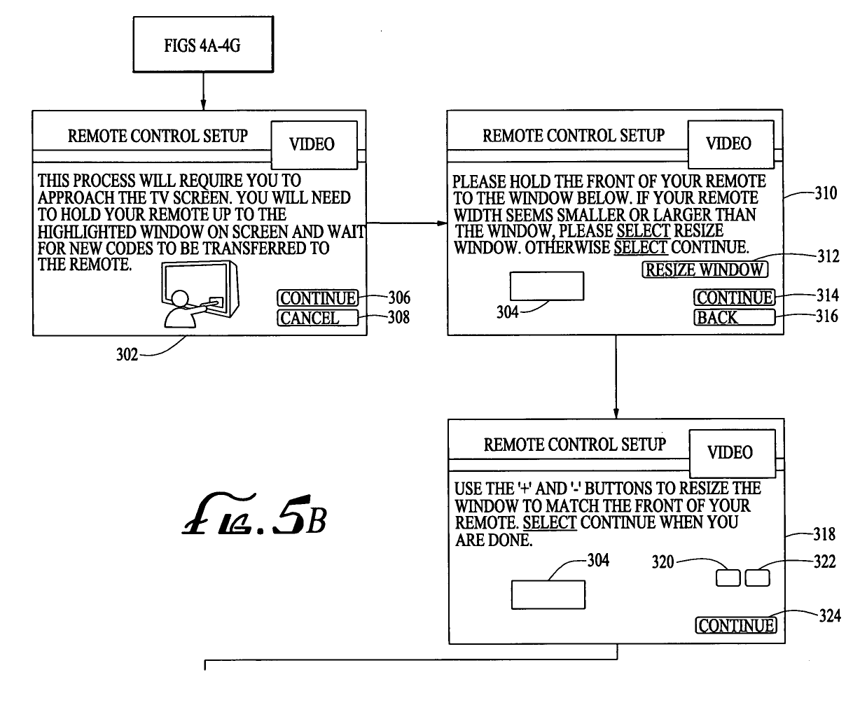

The set top box 32 will send one or more records from the code library in the memory 104 of the set top box 32 to the code library or database in the memory 202 of the remote control device 50 as update messages (as illustrated in FIGS. 4A-5C). Each record is associated with a device code that is itself associated with one or more device commands, as outlined above. In this manner, transfer of a record from the code library of the set top box 32 transfers the device codes and device commands associated with that record to the code library of the remote control device 50. This is done by encoding data comprising the record(s) to a video stream (e.g., a custom-built mpeg) comprising a flashing visible-light sequence of alternating black boxes or frames and white boxes or frames (where a black frame represents a digital ‘0’ and a white frame represents a digital ‘1’ or vice versa). In this manner, data (i.e., the records) in the form of digital ones and zeroes is communicated to the remote control device 50 in the form of modulated visible-light. The foregoing colors and duration of the digital ones and zeroes can be implemented in other forms (i.e., the digital “1” and digital “0” can be in various forms including, a pulse of white is a digital “1” while a pulse of black is a digital “0”, a digital “1” comprises unequal pulses of black and white while a digital “0” comprises equal pulses of black and white, etc.). Other implementations could exist, such as showing different symbols, either in the form of multiple symbols for a larger range of values (e.g. two hundred fifty six (256) unique symbols to represent a byte), or an encoded symbol (e.g. a bar code). Alternately, variations in light intensity and/or color could be used to differentiate data values. The frame rate is at thirty (30) Hz (i.e., thirty (30) bits per second) with one (1) byte per key associated with remote control device 50. The video stream is displayed on the television 40 in a dedicated area 58 on the display 40 that is sized and configured to generally match the dimensions of an end of the remote control device 50. The general matching of the dimensions provides that the dedicated area 58 is not too big on a large screen display (e.g., large screen TV) or too small on a small screen TV. The video stream sequence is generated by software/hardware in the set top box 32, as explained in more detail below. A light sensor 60 is located on the end of the remote control device 50 sized and configured to generally match the dedicated area 58. Sizing of the dedicated area 58 also assists the user in reducing the incidence of light on the light sensor 60 that does not originate from the video stream. The light sensor 60 will detect the changes in light in the video stream shown in the dedicated area 58 and decode these light changes into a new code library entry. Alternatively, instead of a video stream, an on-screen display or graphics generated by the set top box 32 can be used to flash the visible-light. An interruption of the CPU within the set top box 32 could cause the on-screen graphics to introduce delays in the sequence so the on-screen graphics will be adapted to be prioritized in the same manner as a video stream in order to prevent delays from occurring. The adapted protocol will be able to handle large changes in timing and not assume that the bits arrive approximately at the expected time. In yet another alternative, an LED on the set top box 32 (e.g., the LED used to indicate whether the set top box 32 is powered up or not) can be used as the mechanism for flashing visible-light to the remote control device 50 (with the lack of signal-to-noise ratio in the power LED being compensated for) with the on and off states of the LED correlating to digital ones and zeroes. On-screen graphics can comprise a video layer and a two-dimensional graphics layer where part of the GUI blinks on and off. In a further alternative, a personal computer and connected to a personal computer monitor can be used to create the flashing, either through a video stream such as mpeg or shockwave flash, or through direct graphics manipulation.

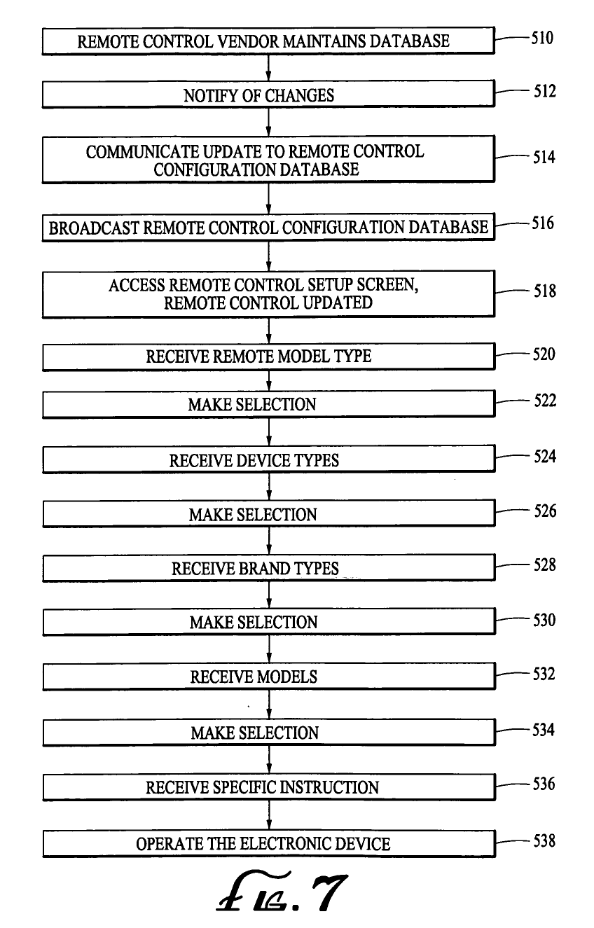

As outlined above, the code library is a database that contains the information for how the remote control device 50 should control other electronic devices 52. FIG. 9 illustrates the form of a database record 62 which includes a record header 64 that contains an identifier for the record 62 in the form of a five (5) digit number. The record 62 also includes an executor 66 that describes how the remote control device 50 should communicate with the electronic device 52. The executor 66 may be a simple reference to an already known protocol such as NEC or Philips RC5, or could be a description of a custom protocol. The record 62 additionally includes a key set 68 that describes how keys on the DIRECTV remote control device match the keys on the remote control that originally came with a particular electronic device 52 and what data should be sent on key presses.

With respect to an illustrative example of a communication protocol, when the database record 62 is to be transmitted, the database record 62 is first encoded in a transmission protocol format. FIG. 10 illustrates steps in the encoding of data 70 and the building of a data frame 72. The data 70 in inserted into the data frame 72. An encoded burst 74 includes a header or preamble 76, a number of blocks 78 in which portions of the data frame 72 (i.e., data chunks 80) are inserted, and a two (2) bit keep-alive (KA) 82. The header 76 allows a circuit to measure the signal variations and adjust circuit settings prior to signal start. The header 76 also contains a special sequence of bits that allows for the detection of exactly when the transmission starts. A command field 84 indicates the type of data 70 and actions for the remote control device 50 upon reception. A length field 86 is added to the data frame 72 to indicate the length of the transmission and a checksum (CHK SUM) 88 is appended to the data frame 72 to allow for verification of data integrity. The data 70 is then broken up in blocks 78 of four (4) bytes. The preamble or header 76 is added to the front of the encoded burst 74 and keep-alive (KA) bits 82, with the pattern “10” are inserted between the blocks 78. The KA bits 82 are inserted in the video steam at known places to allow for detection of timing slip or incorrect reception; allowing for an early termination or resynchronization. The protocol can be adapted to one that includes an upper limit for the number of consecutive identical bits to control the variations in DC through an electrical circuit. It should be noted that the foregoing is for purposes of illustration only and that the communications protocol can be implemented in different ways (e.g., the communication protocol may not need KAs; the KAs do not need to be “10”; there is no need for a preamble or the preamble may be different; etc.).

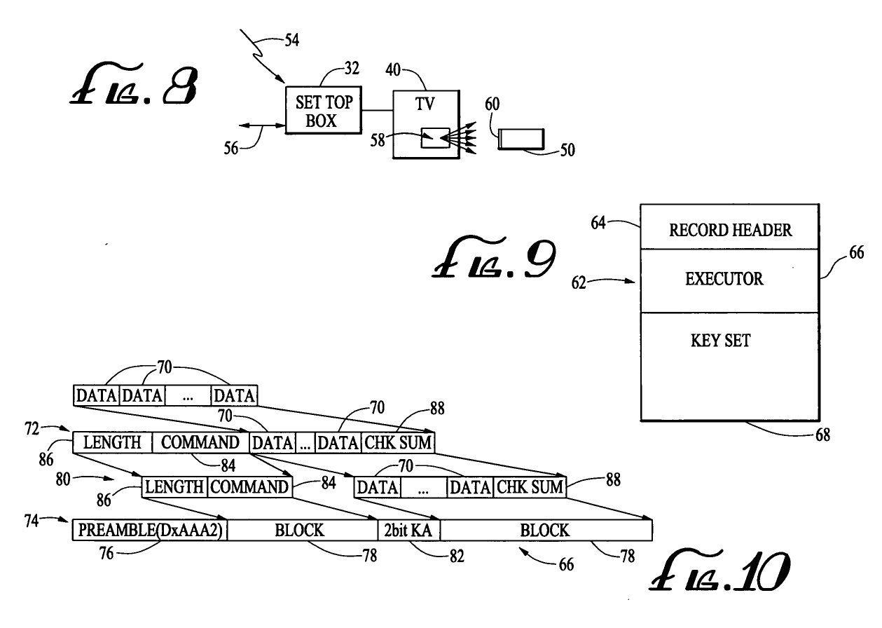

With respect to video signal generation, as seen in FIGS. 2 and 11, the database (or portions of the database) is received by the set top box 32 through the satellite signal 54. The received data is demodulated in an RF demodulator 90 and routed to a central processing unit (CPU) 92 of the set top box 32. The CPU 92 stores the data records on local storage 94 for later use.

As outlined above, a video signal comprises modulated light in the form of a sequence of black boxes or frames and white boxes or frames, where a black frame represents a digital zero (‘0’) and a white frame represents a digital one (‘1’). As outlined above, the digital ones and zeros can be implemented in various other ways including a digital one (or digital zero) being identified by two equal boxes or frames of black and white, or by two different length boxes of black and white, etc. This video signal can be generated in a number of ways including, without limitation, two ways, through a video stream, by using on-screen graphics or the like. If a video stream is used, the CPU 92 will encode the data record of interest with the above-described protocol and build an mpeg video stream from the encoded data. This video stream is routed to a video decoder 98 where the mpeg video stream is decoded and sent to the television (i.e., the display 40). Alternatively, the video stream can be routed through a transport multiplexer 96 to the video decoder 98. If on-screen graphics are used, when needed the CPU 92 will encode the data record of interest with the above-described protocol and generate on-screen graphics of the data. The on-screen graphics is sent to a graphics engine 120 for rendering and is then mixed with a video stream in a mixer 122 and ultimately sent to the television (i.e., the display 40). Alternatively, the on-screen graphics does not have to be mixed with the video stream (e.g., the video stream may be turned off).

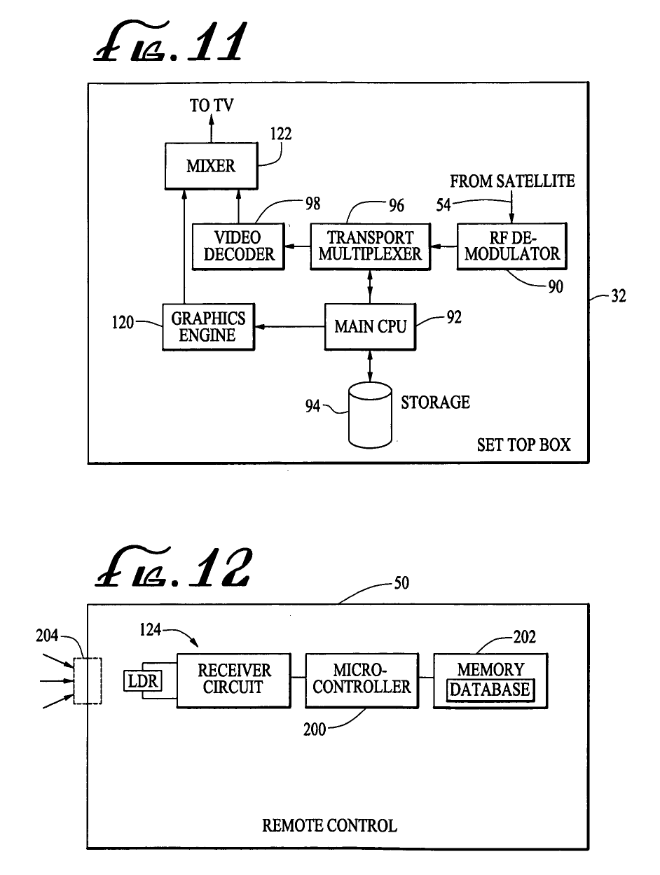

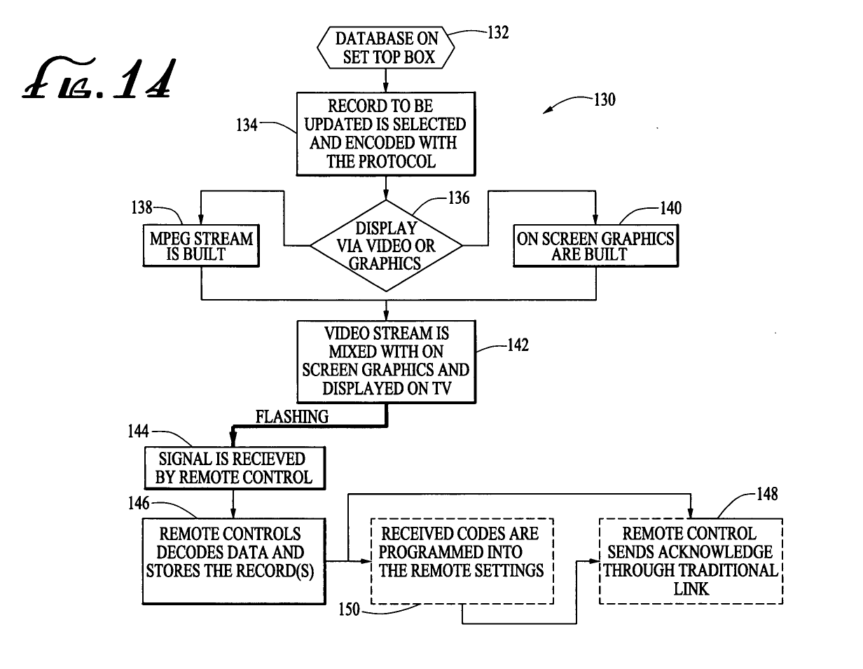

With respect to light detection within the remote control device 50, as seen in FIGS. 3, 8, 12 and 13, the light sensor 60, as illustrated by a light detection circuit 124, is based on a light sensitive component (i.e., a transducer) that registers changes in light and transforms these to an electrical signal which is then amplified and detected by the microprocessor. As seen in FIG. 12, a mechanism for receiving visible light in the remote control device 50 comprises a light sensitive component that comes in various forms including, but not limited to, a light dependent resistor (LDR) (shown in FIG. 12; also referred to as a photoresistor, a photoconductor, a photocell or the like), a photodiode, a phototransistor, a temperature-sensitive device (i.e., light changes temperature) or the like. The LDR is made from a high-resistance semiconductor and can be chosen so that sensitivity to a desired wavelength(s) of light is optimized, and or an optical filter can be inserted in front of the LDR to limit interfering light. Light hitting the LDR causes resistance to fall (resistance decreases with increasing incident light) and allows current to flow through the LDR. Current from the LDR enters a receiver circuit where the current is converted into a voltage. The receiver circuit is part of the transceiver module 206 connected to the microcontroller 200. The microcontroller 200 runs a program that converts the voltage from the transceiver module 206 into a device code (and associated device commands) that is then stored in the code database in the memory 202. In essence, the microcontroller 200 converts the visible-light signals back to logic ‘1’ and ‘0’s which will be assembled by the microcontroller 200 to form the original transmitted code data to be stored in the memory 202 of the remote control device 50. FIG. 13 illustrates a simple circuit diagram representation of an alternative light detection circuit that uses a phototransistor (Q1) as the transducer in a common-emitter configuration. The light-detection circuit 124 may be enabled/disabled by letting the microprocessor 200 control the power supply rail. The phototransistor Q1 can be chosen so that sensitivity to a desired wavelength(s) of light is optimized, and or an optical filter can be inserted in front of the phototransistor to limit interfering light. The use of filtering enables the remote control device 50 to work accurately in a multitude of conditions, such as flashing light of different wavelengths/frequencies. Ensuring adequate light levels is addressed since, in a typical setting, there may be variations in ambient light and variations in the light intensity of the light flashed from the display 40. A lens 204 can be positioned on the end of the remote control device 50 between the display 40 and the phototransistor Q1 in order to focus the flashing visible-light received by the remote control device 50 on the phototransistor Q1. The lens 204 may vary in size and run the entire width of the end of the remote control device 50. Using filters (e.g., in the form of special coatings on the lens 204 or specialized lens materials) in the remote control device 50 to filter out specific wavelengths of light (i.e., specific colors or wavelengths of the electromagnetic spectrum) helps to minimize the impact of ambient light hitting the phototransistor Q1. The output from the phototransistor Q1 is fed to an amplifier which may include automatic gain control (AGC) and filtering prior to feeding the signal to the microprocessor (i.e., the micro-controller 200). The use of AGC enables the light detection circuit of the remote control device 50 to work accurately in a multitude of conditions, such as variations in ambient light in a room where the data transfer is taking place, variations in brightness and contrast settings of different televisions as well as changes in distance when the user is holding the remote control device 50 against the television (i.e., the display 40) during the updating process 300. Filtering is performed in an amplifier before the current is input to the microprocessor or microcontroller 200. For higher frequencies, the filter may be needed to compensate for pulsing light from over-scan signals on the display 40 or from pulsing light from fluorescent light in the room. For lower frequencies, the filter may be needed to compensate for slow variations in ambient light. Ambient light can be reduced by placing a light shield around an end of the remote control device 50 to be programmed/updated. The light shield (similar in function to a camera lens hood) can be attached around the end of the remote control device 50 facing the display in order to reduce levels of ambient light being picked up by the light detection circuit. In another alternative, the visible-light flashed by the display 40 may be a specific bandwidth(s) of light that is less than the full-spectrum encompassed by white light with the light detection circuit being capable of only detecting only this specific bandwidth(s). In an additional embodiment, the light sensor 60/light detection circuit 124 and transceiver module 206 may be adapted for optical recognition of symbols.

FIG. 14 provides a simplified process flow 130 for updating one or more records in the remote control device 50. Device codes are stored in the database of the set top box 32. There is a file or record for each device code which is correlated in a table stored within the memory 94, 104. As described above and below, the set top box 32 reads the record(s) associated with the code(s), and builds an mpeg video file or graphics played on the screen of the display 40. In step 132, codes are stored within the code database located on the memory storage 94, 104 in the set top box 32. In step 134, the code record to be updated is selected and encoded with the protocol described above. In step 136, a choice can be made between displaying via video or graphics. If video is chosen, in step 138 an mpeg stream or equivalent is built. If graphics is chosen, in step 140 on-screen graphics are built. The mpeg stream or graphics is built on the fly from the records from the database. Alternatively, the codes (in the form of an mpeg file or graphics file) are stored in the database of the memory 104. Whether mpeg file or graphics file, in step 142 a video stream is mixed with mpeg file and/or on-screen graphics and displayed on the television so that a visible-light signal from the video stream/on-screen graphics is flashed to and received by the remote control device in step 144. The video stream is played once on the screen. The video sequence can be built in advance or dynamically on the set top box 32. Building the video sequence dynamically on the set top box 32 minimizes the memory usage of having to store pre-built data. The light signals may be of different forms, as outlined above (i.e., the digital one (“1”) and digital (“0”) can be in various forms including, a pulse of white is a digital “1” while a pulse of black is a digital “0”, a digital “1” comprises unequal pulses of black and white while a digital “0” comprises equal pulses of black and white, etc.). As outlined above and below, a binary ‘1’ is encoded to a white box or frame and a binary ‘0’ to a black box or frame. Other implementations could exist, such as showing different symbols, either in the form of multiple symbols for a larger range of values (e.g. two hundred fifty six (256) unique symbols to represent a byte), or an encoded symbol (e.g. a bar code). Alternately, variations in light intensity and/or color could be used to differentiate data values. The remote control decodes data from the visible-light signal and stores the record(s) in step 146. The remote control then sends an acknowledge through a traditional link in step 148. However, the sending of an acknowledgement can be optional. Alternatively, before the remote control sends the acknowledge, the received codes are programmed into the remote settings in step 150.

Referring to FIG. 4A, an overview of a process 230 for updating a remote control device 50 is illustrated that comprises a plurality of screen displays of a graphical user interface (GUI) 232 which forms the basis of a mechanism for flashing visible-light to the remote control device 50. For purposes of illustration only, the remote control device is a DIRECTV remote control device. FIGS. 4B-4G are enlarged views of various portions of the process 230. The screen displays of the GUI 232 may ultimately include various instructions and selections for programming the remote control device 50. The screen displays may be generated by the display control module 116 of FIG. 2. A user activates a code database updating function by depressing one or more keys on the keypad module 208 of the remote control 50 while pointing the remote control device 50 towards the set top box 32, using the transmitter module 206 to transmit RF, IR or visible light signals to the interface 110 of the set top box 32. Alternatively, the set top box 32 includes buttons/keys that can be used for setting up the process 230. Otherwise, the remote control device 50 instructs the set top box 32 to go into program mode by the user pressing and holding a key on the remote control device 50. After that, the remote control device 50 has no control over the process 230 other than to make selections from choices on the display 40. The keypad 112 on the set top box 32 can also be used to make selections from choices on the display 40.

Once the remote control setup program is launched by the set top box 32, the graphical user interface 232 on the display 40 display a selection screen 234 for the user to choose an input (FIG. 4B). The user is prompted to press SELECT on the TV to program TV keys in all modes (TV power, TV input, VOL, MUTE). The user is asked to select AV1 or AV2 to program the remote control device 50 to control a DVD, VCR, stereo or second DIRECTV receiver. The user can select the desired choice by using input keys on the keypad module 208 of the remote control 50 or the keypad 112 of the set top box 32 to highlight the desired choice. Once an input has been chosen, the GUI 232 displays another selection screen 236 for choosing a product and a brand. The user manipulates the keys on the remote control device 50 to highlight or otherwise indicate the user's desired selection. Once the selection is highlighted or otherwise indicated, the user is prompted to press the SELECT button on the remote control device 50 on the product type and brand of the device the user wants to program into the remote control device 50. For purposes of illustration, and not limitation, a non-exclusive list of products displayed include a DVD, stereo, VCR, DIRECTV Receiver, and a TV. Once the user manipulates the input keys on the keypad module 208 of the remote control 50 or the keypad 112 on the set top box 32 to highlight the desired product in a product box 238 (FIG. 4C). Once the product is selected in the product box 238, the communications module 102 and the set top box 32 may then receive information on various brands of televisions being broadcast in the remote control configuration database which are then displayed in the brand box 240 (FIG. 4D). The selection screen 236 then provides prompts for selecting various brands. For example, it is illustrated that a DVD product has been selected and a list of brands (e.g., Allegro, Apex Digital, Blaupunkt, Blue Parade, Brocsonic, etc.) are displayed. Again, the keys of the remote control device 50 (or the keys on the set top box 32) are used to highlight or otherwise indicate the desired brand selection (e.g., in this case, Apex Digital is selected). If a brand is chosen, the user is then prompted by another selection screen 242 of the GUI 232 to choose a model by pressing SELECT on the model of the device the user wants to program into the remote control device 50. As seen in FIG. 4D, the selection screen 242 illustrates various types of models (e.g., 112-R, 120-S, 345-S, 220-M, 99-D, etc.) in a model box 244. Numerous models may be available for any particular manufacturer. In this example, model 120-S is selected.

Referring now to FIG. 4C, specific instructions in response to the selected model are displayed on a remote control selection screen 246 for programming a remote control device 50 with a known model. The specific instructions may include a code used for selecting a particular configuration within the remote control device 50. As illustrated in FIG. 4C, for model 120-S, there is one possible code (e.g., 10761). For Step 1, the user is prompted to, on the remote control device 50, move MODE switch to AV1. Then, press and hold MUTE and SELECT until a light (typically, a light-emitting diode) on the remote control device 50, typically located above the keypad on the face of the remote control device 50, flashes twice. For Step 2, the user is then prompted to enter the code using the remote control device's 50 number keys or alternatively, using the keypad 112 on the set top box 32 to enter the code. The user is then prompted to press PWR (i.e., power). If the DVD powered on, the user is instructed to move MODE to DIRECTV and then select DONE 248. If the DVD did not power on, the user is told to repeat Step 1 and enter the next code. If the user has tried all the codes shown, the user is instructed to move MODE to DIRECTV and then select UPDATE REMOTE CONTROL 250.

If UPDATE REMOTE CONTROL 250 is selected, the user is directed to another process 300 for updating the remote control device 50, illustrated in FIGS. 5A-5C, that comprises another plurality of screen displays of the GUI 232. FIG. 5A, illustrates an overview of the process 300 for updating a remote control device 50. FIGS. 5B and 5C are enlarged views of various portions of the process 300 for remote control setup. A screen 302 of the GUI 232 on the display 40 informs the user that this process 300 will require the user to approach the TV screen of the display 40 (of whatever type of monitor device is in use) and that the user needs to hold the remote control device 50 up to a highlighted area or window 304 on the screen and to wait for new codes to be transferred to the remote control device 50. A black background may be provided around the area 304 in order to reduce additional ambient-light from the television being picked up by the light-detection circuit of the remote control device 50. This non-flashing dark border would be projected on the display 40 surrounding the visible-light flashing area 304 projected on the display 40. The user is prompted to use input keys on the remote control device 50 to hit CONTINUE 306 or CANCEL 308. Once the user chooses CONTINUE, a new screen 310 on the GUI asks the user to please hold the front of the remote control device 50 to the window 304. The screen 310 prompts the user to select RESIZE WINDOW 312 if the dimensions of a light-receiving end of the remote control device 50 seems smaller or larger than the window 304. Otherwise, the user is prompted to select CONTINUE 314. The user also has the option of selecting BACK 316 in order to return to the previous screen 302. If the user selects CONTINUE 314, another screen 318 prompts the user to use the plus (“+”) and minus (“−”) “buttons” 320, 322 on the screen 318 by highlighting and selecting the buttons 320, 322 on the screen 318 using the keys on the remote control device 50 or keypad 112 of the set top box 32. Alternatively, the user may use plus (“+”) and minus (“−”) keys located on the remote control device 50. This serves as one aspect of a mechanism for adjusting the mechanism for flashing visible-light by letting the user resize the window 304 for flashing visible-light which optimizes the light intensity (e.g., size the window 304 up on small displays 40) and helps to avoid user discomfort (e.g., size the window 304 down on large displays). Once the user has used the plus (“+”) and minus (“−”) “buttons” 320, 322 to resize the window 304 to match the dimensions of the front of the remote control device 50, the user is prompted to use the keys on the remote control device to select CONTINUE 324 when the user is done.

A new screen 326 prompts the user to approach the screen within a period of time identified by a countdown box 328 on the screen 326. Typically, the user will be given thirty (30) seconds to approach the screen 326 but this time period may be adjusted to provide longer or shorter durations. The user is also instructed to hold the front of the remote control device 50 adjacent to a box or window 330 at the lower right portion of the screen 326. Positioning the remote control device 50 adjacent to the window 330 reduces ambient visible-light and/or visible-light from light sources other than the display from incoming to the remote control device 50. Alternatively, the window 330 may be positioned anywhere on the screen 326. A new screen 332 includes a graphic 334 illustrating how the user is supposed to hold the remote control device 50 against the screen of the display 40 while the countdown box 328 continues to indicate the decreasing amount of time the user has to comply with the instructions. When the countdown reaches zero (0), the countdown box 328 disappears and the window 330 flashes visible light as part of a video feed or stream (in a manner described in more detail below) to a light-sensor (described in more detail below) located on the end of the remote control device 50 adjacent to the window 330. The flashing of the visible light transmits the new codes to the remote control device 50. A download indicator 336 illustrates (e.g., zero percent to one hundred percent) how much of the code has been transmitted to the remote control device 50. When the code download to the remote control device 50 is complete, a new screen 338 appears informing the user that the code database of the remote control device 50 has been updated and instructs the user to select the DONE button 340 to complete the process 300 and automatically restart the process 230 to program the remote control device 50.

However, an alternative selection process occurs if a user selects “Model Not Found” in the model box 244, as seen in FIG. 4E, and the number of codes for that brand is less then five (5) with specific instructions displayed on a remote control selection screen 252, similar to the screen 246, for programming the remote control device 50 for the unknown model. As illustrated in FIG. 4F, for the brand of the unknown model, there are two possible codes (e.g., 10761 and 10783). For Step 1, the user is prompted to, on the remote control device 50, move MODE switch to AV1. Then, press and hold MUTE and SELECT until a light (typically, a light-emitting diode) on the remote control device 50, typically located above the keypad on the face of the remote control device 50, flashes twice. For Step 2, the user is then prompted to enter the code using the remote control device's 50 number keys. Then user is then prompted to press PWR (i.e., power). If the DVD powered on, the user is instructed to move MODE to DIRECTV and then select DONE 248. If the DVD did not power on, the user is told to repeat Step 1 and enter the next code. If the user has tried all the codes shown, the user is instructed to move MODE to DIRECTV and then select UPDATE REMOTE CONTROL 250 which directs the user to the process 300 for updating the remote control device 50, illustrated in FIGS. 5A-5C, and described above. Once the user goes through the updating process 300, the user is now able to use the newly downloaded codes to program the remote control device 50 using the process 230.

Yet another alternative selection process occurs if a user selects “Model Not Found” in the model box 244, as seen in FIG. 4E, and the number of codes for that brand is greater than or equal to five (5) with specific instructions displayed on a remote control selection screen 254, similar to the screens 246, 252, for programming the remote control device 50 for the unknown model. As illustrated in FIG. 4F, for the brand of the unknown model, there are five possible codes (e.g., 10761, 10783, 10842, 10799 and 10956). To narrow down the options, the user is instructed to go to a website to search for the most likely codes. For Step 1, the user is prompted to, on the remote control device 50, move MODE switch to AV1. Then, press and hold MUTE and SELECT until a light (typically, a light-emitting diode) on the remote control device 50, typically located above the keypad on the face of the remote control device 50, flashes twice. For Step 2, the user is then prompted to enter the code using the remote control device's 50 number keys. The user is then prompted to press PWR (i.e., power). If the DVD powered on, the user is instructed to move MODE to DIRECTV and then select DONE 248. If the DVD did not power on, the user is told to repeat Step 1 and enter the next code. If the user has tried all the codes shown, the user is instructed to move MODE to DIRECTV and then select NEXT 256 which directs the user to another screen 258 (FIG. 4G) which provides additional codes to be entered in the same manner as Steps 1 and 2 described above. However, if the user has tried all the codes shown, the user is instructed to move MODE to DIRECTV and then select UPDATE REMOTE CONTROL 250 which directs the user to the process 300 for updating the remote control device 50, illustrated in FIGS. 5A-5C, and described above. Once the user goes through the updating process 300, the user is now able to use the newly downloaded codes to program the remote control device 50 using the process 230.

While the processes 230, 300 described above are illustrated using a DIRECTV remote control, the process 230 can include a user making a selection from a plurality of different types or models of remote control devices 50 (e.g., a remote control for a particular type/brand/model of electronic device, a universal remote control, etc.) to program. The process 300 may automatically size the window 304 for the programming of a known type or model of remote control device 50. It should be noted that the keys on the set top box 32 can be used during the programming processes 230, 300 as an alternative to using the keys on the remote control device 50.

As will be described below, when moving from display-to-display, various information may be selected from the continually-broadcast remote control configuration database. The information received will be used to populate the screen display. Referring now to FIG. 6, a portion of a broadcast stream 400 having the remote control configuration database is illustrated. The remote control configuration database may be broadcast in a carousel-type manner. That is, the data may continuously be broadcast at a lower speed than that of normal content. Various types of information may be broadcast including, without limitation, remote control model 402, device type information 404, brand information 406, model information 408, and instruction information 410. This information may be repeated for various brands, types and models. As mentioned above, this may be broadcast continually to allow the set top box 32 to receive the information required to form the various displays described above in FIGS. 4A-5C. In this manner, the whole remote control database is not required to be stored within the set top box 32, thus freeing up memory for other purposes. Updates may be periodically inserted into the broadcast data stream.

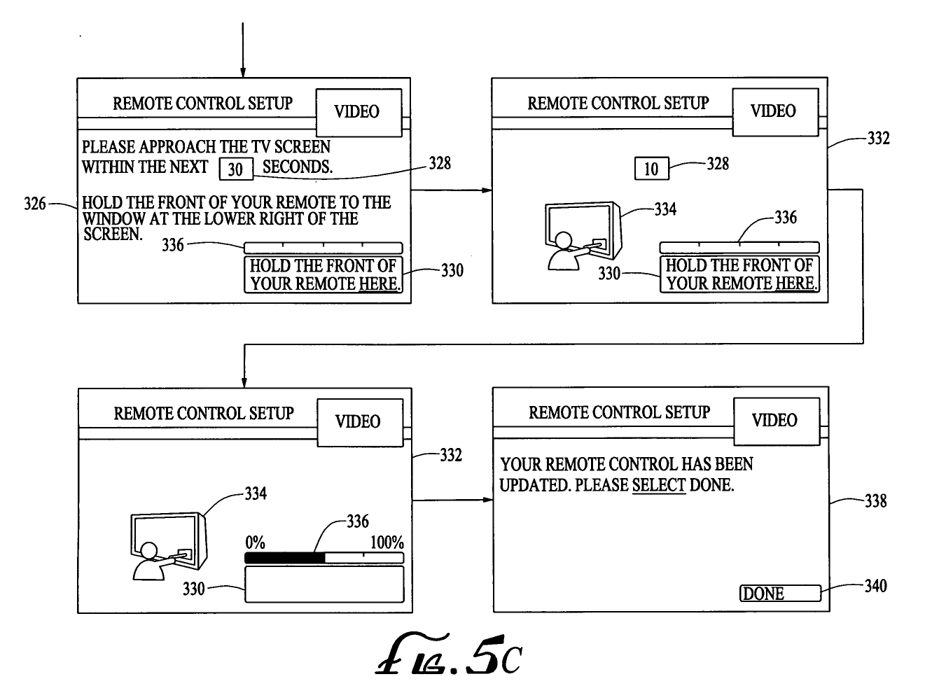

Referring now to FIG. 7, one method 500 for operating the remote control configuration system is set forth. In step 510, as new products are developed, the database is updated. The product vendor, remote control suppliers for the product vendors or other may update the database. In step 512, notification may be performed that changes have been made to the database. The presence of the changes may be communicated to the communication module 42 illustrated in FIG. 1. In step 514, the updates to the remote control database 48 may be communicated from the vendor server 44 to the database 48. This may be instigated periodically at the communication module 50 illustrated in FIG. 1 or upon receipt of a notification such as that in step 512. In step 516, the remote control configuration database 48 is broadcast in a continual manner from the head end 22. The broadcast management module 28 may be used to control the broadcasting of the remote control configuration database 48. When the remote control configuration database 48 is updated, the updates are automatically inserted into the carousel for broadcasting the remote control database 48. In step 518, the remote control set-up screens (FIGS. 4A-5C) are accessed by a user by activating one of the interfaces 110 illustrated in FIG. 2. The remote control set-up screens may be accessed through selections on the keys of the remote control 50 or on a key pad on the set top box 32. In this manner, the code database/library in the remote control device 50 is updated in the manner described above and below. In step 520, the remote control model types are received. In step 522, a selection of the model type is performed. In step 524, various device types may be received through the broadcast remote control configuration database 48. Once the types of device are received, a selection may be made using one of the interfaces in step 526. Upon selection of the device type, the brand types may be received and displayed on the display 40 in step 528. In step 530, a selection is made for the type of brand. The set top box 32 then receives the portions of the remote control configuration database 48 corresponding to the models. In step 532, the model identifiers are provided on the display 40. In step 534, a model is selected. In step 536, specific instructions may be received in response to the specific model. For example, various instructions may include depressing certain buttons or entering certain codes. Once the remote control device 50 is programmed, the remote control device 50 may be used to operate the electronic device 52 (step 538). As can be seen, the remote control device 50 can also be programmed for various numbers of different devices 52, if desired. Known types of selector switches may be provided for selecting audio, visual, TVs, and the like on various types of remote control devices 50. Each selection may be programmed separately.

In the alternative, the system and method described above can be adapted to use audio (i.e., sound) by itself or in combination with visible light to program a remote control device 50 having an audio receiver with updated codes.

The system and method described above can be adapted to transmit data between any device capable of flashing light in the manner described above and any device capable of receiving and processing light flashed to the device in the manner described above. For example, a set top box 32 connected to a display 40 (or personal computer connected to a monitor) can be used in the manner described above to transmit any type of data to any type of device adapted to receive and process flashed visible-light. In this manner, data can be transmitted to devices other than remote controls 50 such as a personal digital assistant, a personal computer, an ipod, an iphone, a cellular telephone, a digital camera or the like. Likewise, any device capable of transmitting and/or receiving information (e.g., a personal digital assistant, a cellular telephone or any device described above or its equivalent) can be used as an alternative to the set top box 32.

Additional embodiments of the present invention may be made by combining various elements of one of the above-described embodiments with various elements of another one or more of the above-described embodiments.

The above-described embodiments of the present invention are illustrative only and not limiting. It will thus be apparent to those skilled in the art that various changes and modifications may be made without departing from this invention in its broader aspects. Therefore, the appended claims encompass all such changes and modifications as falling within the true spirit and scope of this invention.

What is claimed is:

1. A system for delivering device codes to a remote control having a device code database whereby the remote control is capable of controlling a number of electronic devices via at least one device code specific to each electronic device, comprising:
a transmitter;
a receiver receiving a signal originating from the transmitter; and
a display operationally connected to the receiver, having means for flashing visible-light to the remote control, wherein the flashed visible-light is related to the signal;
wherein the remote control includes means for receiving the flashed visible-light, and means for converting received visible-light into at least one device code to be stored in the device code database.

2. The system of claim 1, wherein the remote control is positioned adjacent to the display in order to reduce visible-light incoming to the remote control from light sources other than the display.

3. The system of claim 1, wherein the means for flashing visible-light comprises a graphical user interface on the display.

4. The system of claim 1, wherein the means for flashing visible-light comprises an area of the display running a video stream.

5. The system of claim 4, wherein the area is adjustable in size to accommodate a light-receiving end of the remote control.

6. The system of claim 5, further comprising a light shield engaging the remote control about the light-receiving end in order to reduce the amount of ambient visible-light reaching the light-receiving end of the remote control.

7. The system of claim 1, wherein the means for flashing visible-light comprises a non-flashing dark border portion projected on the display surrounding a visible-light flashing portion projected on the display.

8. The system of claim 1, wherein the remote control includes means for adjusting the means for flashing visible-light.

9. The system of claim 1, wherein the means for receiving visible-light comprises an LDR.

10. The system of claim 9, wherein the means for receiving visible-light further comprises a lens disposed between the LDR and the display.

11. The system of claim 1, wherein the means for converting received visible-light further comprises a microprocessor.

12. The system of claim 1, further comprising means for initiating a device code update.

13. The system of claim 1, further comprising a satellite disposed between the transmitter and the receiver, receiving an uplink signal comprising the signal from the transmitter; wherein the signal received by the receiver comprises a downlink signal from the satellite, wherein the downlink signal is related to the uplink signal, and the visible-light flashed to the remote control is related to the downlink signal.

14. The system of claim 1, wherein the uplink signal is related to the at least one device code.

15. A method for acquiring updated device codes for a controlled apparatus, comprising the steps of:
storing a plurality of device codes for a plurality of controlled apparatus in a code database of a remote control
generating data related to additional device codes;
transmitting the generated data from a transmission source to a processing device operationally connected to a display;
flashing the generated data from the display to the remote control;
receiving the flashed visible-light with the remote control;
converting the received flashed visible-light into at least one device code; and
updating the code database in the remote control with the at least one device code.

16. The method of claim 15, wherein the transmitting step further comprises the step of routing the generated data through a satellite network to the display.

17. The method of claim 15, further comprising the step of using the remote control to access the generated data.

18. The method of claim 15, further comprising the step of using the remote control to operate different controlled apparatus, wherein the different controlled apparatus are manufactured by a common manufacturer or different manufacturers.

19. The method of claim 15, further comprising the step of selecting a particular device code from a plurality of device codes to operate a particular controlled apparatus.

20. The method of claim 15, further comprising the step of using at least one of the codes to operate a particular controlled apparatus.

21. The method of claim 20, wherein the particular controlled apparatus is a selected one of a television, a CD player, a DVD player, a DVR, a stereo system, a VCR, a personal computer, a personal digital assistant, a cable converter and a set-top box.

22. The method of claim 15, further comprising the step of adjusting a graphical user interface projected on the display in order to flash the visible-light.

23. The method of claim 15, further comprising the step of initiating a device code update.
